(19) United States
(12) Patent Application Publication
(10) Pub. No.: US 2026/0021885 A1
(43) Pub. Date: Jan. 22, 2026

(54) VISION BASED ANALYSIS FOR THE MEASUREMENT AND CONDITION MONITORING OF AIRCRAFT BRAKE WEAR PIN ASSEMBLIES

(71) Applicant: Goodrich Corporation, Charlotte, NC (US)

(72) Inventors: Kevin J. Delaney, Cedar Rapids, IA (US); Yohan Rosario, Medfort, MA (US); Sherron Goodenough, Salt Lake City, UT (US); Phillip E. Cooley, Kettering, OH (US)

(73) Assignee: Goodrich Corporation, Charlotte, NC (US)

(21) Appl. No.: 18/778,402

(22) Filed: Jul. 19, 2024

(51) Int. Cl. B64C 25/42; F16D 66/02

(52) U.S. Cl. CPC B64C 25/42; F16D 66/022; F16D 66/027

(57) ABSTRACT

A system for outputting a wear pin length relating to a brake pad thickness is provided. The system provides a template, which can be used to capture an image of a wear pin having a length. The template has indica to be matched to indicia on a landing gear bogie where the template indicia are aligned with the landing gear bogie indicia during image capture of the landing gear bogie. Based on the captured image, the system outputs a wear pin length. The system can also estimate a remaining lifetime of the brake pad based on the captures image of the landing gear bogie. A decay curve for the brake pad can be determined based on the captured image and used to estimate a remaining lifetime.

### TECHNICAL FIELD

Examples relate to monitoring an aircraft brake wear pin and more specifically to a system that implements a reference template that can be used to monitor an aircraft brake wear pin.

### BACKGROUND

Aircraft typically include braking components to arrest speed during various maneuvers, such as landing the aircraft. In order to facilitate braking, aircraft can include a braking system having discs and brake pads that grip the brake discs in order to decelerate the aircraft. The brake discs are consumables and can wear over time and lose an ability to dissipate heat during braking of the aircraft. Various factors can contribute to the wear of discs such that the life of the discs is variable over time. These factors can include environmental conditions in which the aircraft is operated, such as hot and dry climates, high altitude locations, hot and humid climates along with how the aircraft is piloted during takeoff and landing.

In order to determine how much life is left for a brake assembly, the thickness of the brake discs are determined. Typically, this involves a visual inspection, where a pilot or a technician visually inspects the discs and visually determines that a thickness of the brake discs is sufficient for further use. Guides can be used where a length of the guide can be indicative of a thickness of the brake discs. The guides include where a pin where a length of the pin can indicate whether or not a thickness of the brake discs is within an acceptable range and suitable for use.

### BRIEF DESCRIPTION OF DRAWINGS

FIG. 1 is a network diagram illustrating a network environment having a server device that can calculate a lifespan of aircraft brake pads based on data received from various devices.

FIG. 2 shows an example of an aircraft having a landing gear bogie that includes aircraft brake discs.

FIG. 3 shows a reference template that the various devices of FIG. 1 can include for measuring guide pin lengths of the landing gear bogie in FIG. 2.

FIG. 4A is a view of the landing gear bogie of FIG. 2 that shows various structures of the landing gear bogie.

FIG. 4B is a view of a brake pad for the landing gear bogie of FIG. 2.

FIG. 5 shows data table that includes a listing of different aircraft types and associated landing gear bogie data.

FIG. 6 is a view of the landing gear bogie of FIG. 2 that shows various structures of the landing gear bogie.

FIG. 7 illustrates a method for using the reference template of FIG. 3 to determine a wear pin length of FIG. 4A.

FIG. 8 shows a user interface that can be presented to user when inspected an brake assembly of an aircraft.

FIG. 9 illustrates a user interface that can be presented to a user that provides instructions relating to orientating an image capture device.

FIG. 10 shows a user interface to be used during image capture of a landing gear bogie.

FIG. 11 is a user interface that provides an output relating a wear pin associated with an aircraft brake pad.

FIG. 12 is a block diagram illustrating architecture of software used to implement social network-initiated listings, according to some examples.

FIG. 13 is a block diagram illustrating a machine as an example computer system with instructions to cause the machine to implement social network-initiated listings, according to some examples.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to a system that can be used to determine a length of a wear pin relative to a wear pin housing of an aircraft braking assembly having a brake pad or carbon stack of rotor and stators on an aircraft. The wear pin length can be indicative of a remaining lifetime of the aircraft brake pad or carbon stack. The wear pin and the brake pad or carbon stack can be located at a landing gear of an aircraft. The system can be implemented on a mobile device where a reference template can be displayed on the mobile device and used to view the wear pin length. The reference template can be displayed on the mobile device when input relating to a type of aircraft and a particular landing gear is provided to the mobile device. The reference template can include reference point indicia that can be used to match with reference points located at the landing gear. The landing gear reference points can relate to static points at the landing gear such as various structures at the landing gear.

An image capture component of the mobile device can be aligned with the landing gear by aligning the reference template point indicia of the reference template with the landing gear bogie reference points using a display of the mobile device. Once the reference template points are aligned with the reference points, an image can be captured with the mobile device. The captured image can be used to determine the wear pin length. In some examples, a visible portion of the wear pin length relative to a wear pin housing can relate to the brake pads or carbon stack associated with the wear pin being usable such as not needing replacement. Additionally, the wear pin length can be used to determine a remaining usable lifetime or impending maintenance actions of the aircraft brake pad or carbon stack.

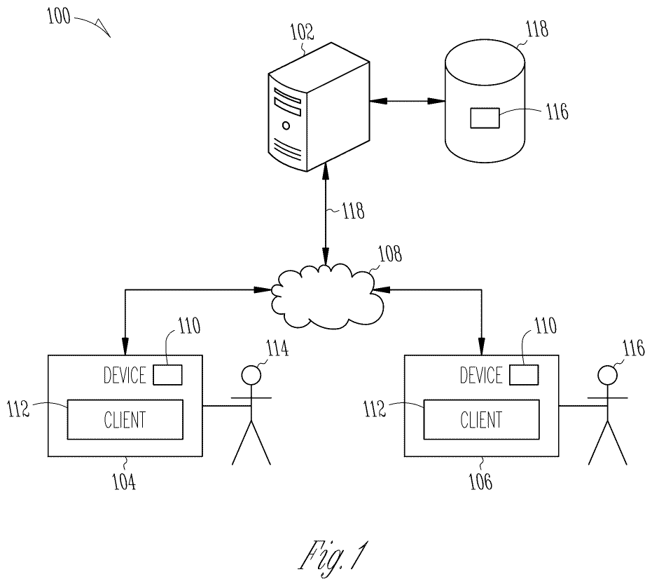

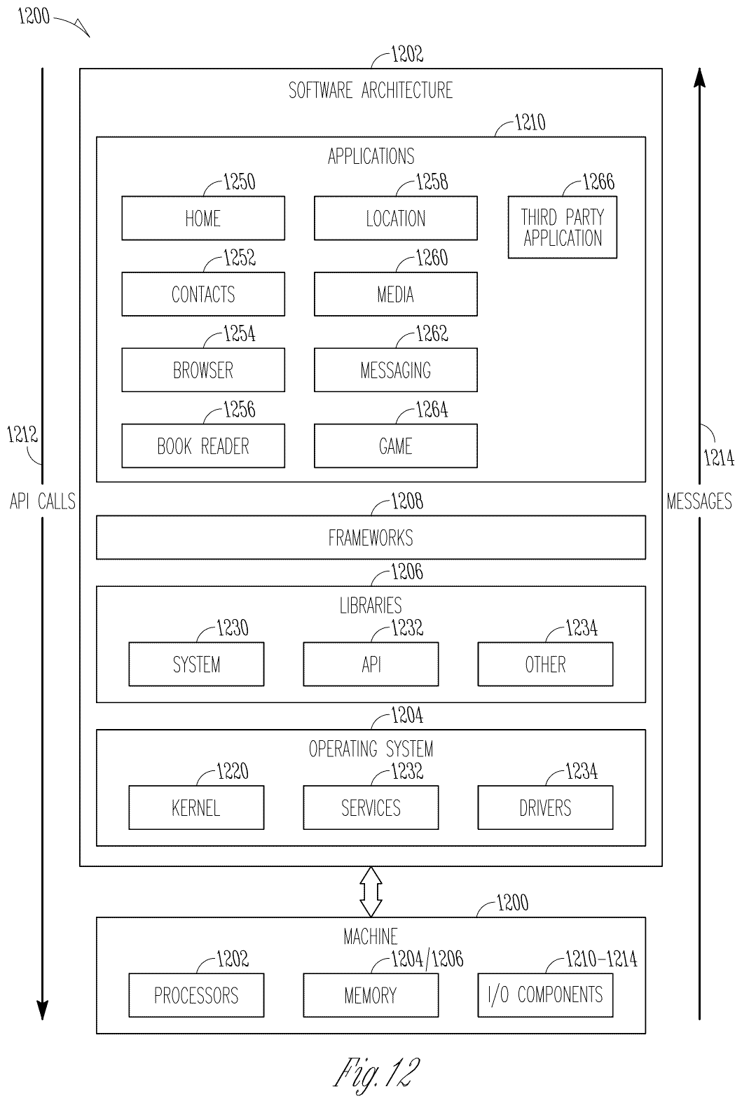

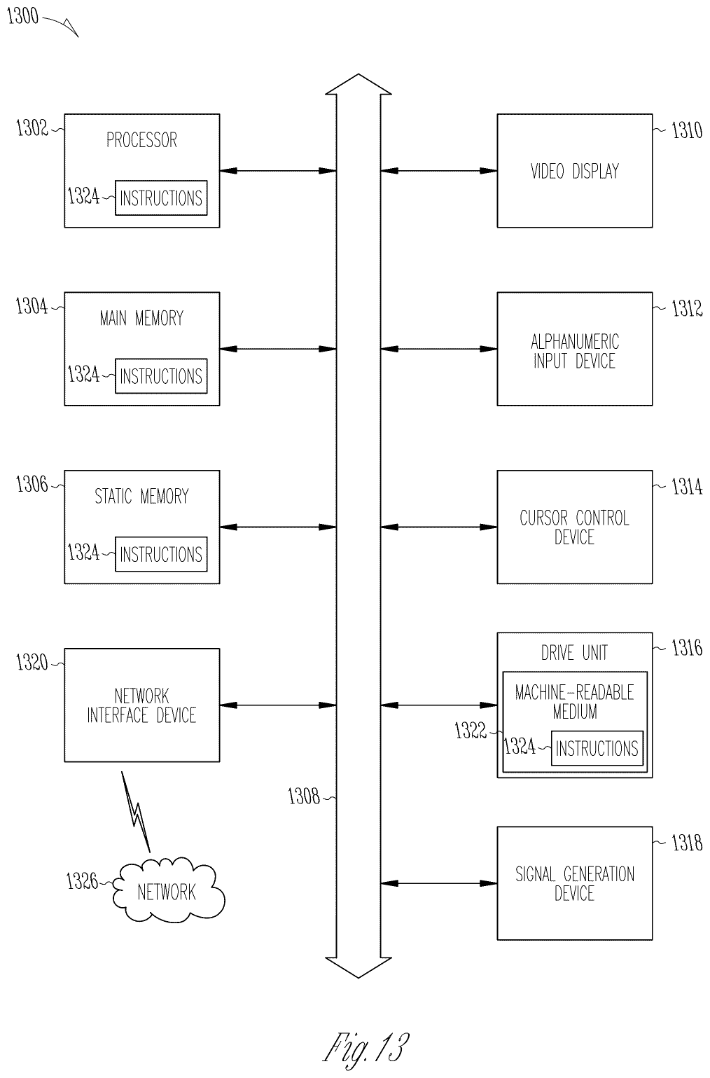

Now turning attention to the Figures, FIG. 1 is a network diagram illustrating a network environment 100 having a server device 102 that can calculate a lifespan of aircraft brake pads based on data received from devices 104 and 106 communicatively coupled to each other and the server device 102 via a network 108. As used herein, reference to the device 104 can also be understood to be a reference to the device 106. Thus, any discussion relating to the device 104 is also applicable to the device 106 and vice versa. The server 102 and the devices 104 and 106 may each be implemented in a computer system, in whole or in part, as described below with respect to FIGS. 12 and 13. The server device 102 can be remotely located from the devices 104 and 106.

The network 108 can be any network that enables communication between or among machines, databases, and devices (e.g., the devices 104 and 106). Accordingly, the network 108 can be a wired network, a wireless network (e.g., a mobile or cellular network), or any suitable combination thereof. The network 108 can include one or more portions that constitute a private network, a public network (e.g., the Internet), or any suitable combination thereof.

Each of the devices 104 and 106 can include an image capture component 110. The image capture component 110 can be a main/standard camera, an ultra-wide camera, or a telephoto/zoom camera. The image capture component 110 can also be a macro camera, can include a depth sensor, and can be a front facing selfie camera. In addition, the image capture component 110 can be a periscope zoom camera, a time-of-flight (ToF) camera, or a monochrome camera or any other type of assembly capable of capturing images.

The devices 104 and 106 can be any computing device suitable for use by a user. For example, the devices 104 and 106 can be a tablet computer, a portable media device, or a smartphone belonging to a user. The devices 104 and 106 can interact with the server device 102 using a web client or app client 112. The client 112 can be enabled by a web browser, which allows for communication between a device, such as the devices 104 and 106, with the server device 102. The client 112 can be an application client that can be a standalone application that can run on one or both of the devices 104 and 106 and communicate with the server device 102 to employ the services on the server device 102, such as a Bluetooth™ client application or the like via the network 108.

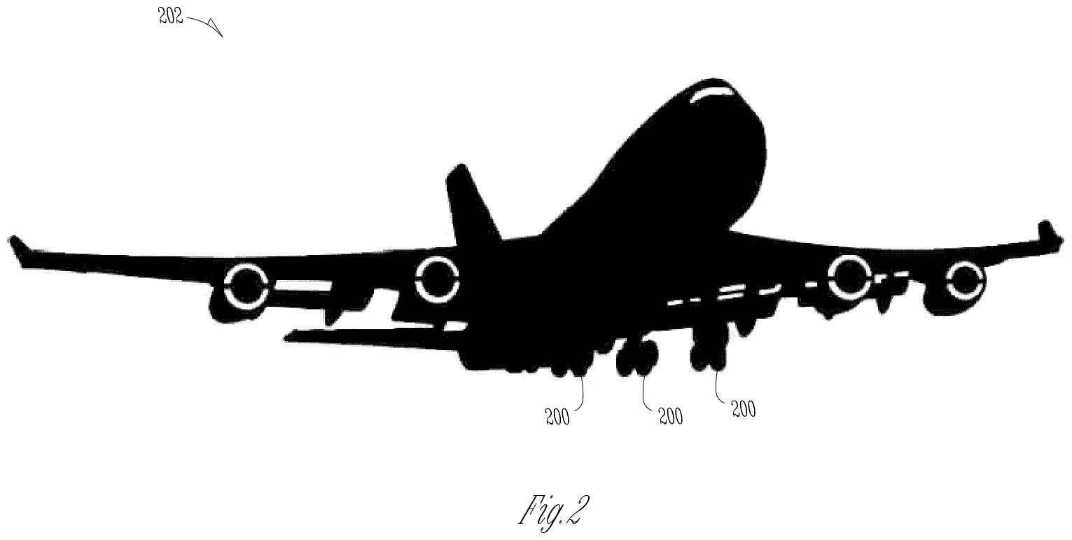

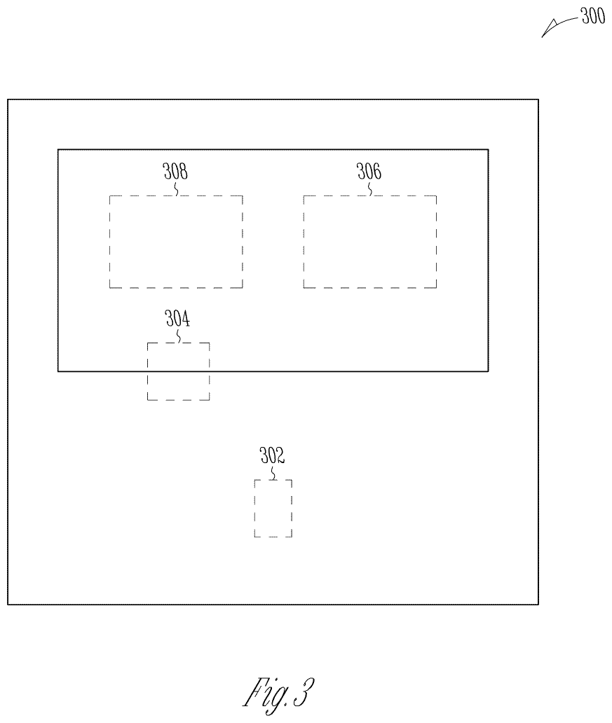

The client 112 can provide the functionality described herein. The client 112 can guide a user 114 or 116 through capturing images of a landing gear bogie 200 for an aircraft 202 (FIG. 2). The client 112 can provide instructions with respect to how a user should orient an image capture device, such as the devices 104 and 106, when capturing an image of the landing gear bogie 200. As discussed herein, how a user should orient the device 104 can include an orientation that can relate to an angle of the device 104 relative to the landing gear bogie 200 along with a distance between the device 104 and the landing gear bogie 200. The client 112 can also provide information relating to proper lighting for capturing an image of the landing gear bogie 200. The client 112 can be configured to a provide a reference template 300 having reference template point indicia 302-308 that can be used to align the image capture component 110 with the landing gear bogie 200 as shown in FIG. 3.

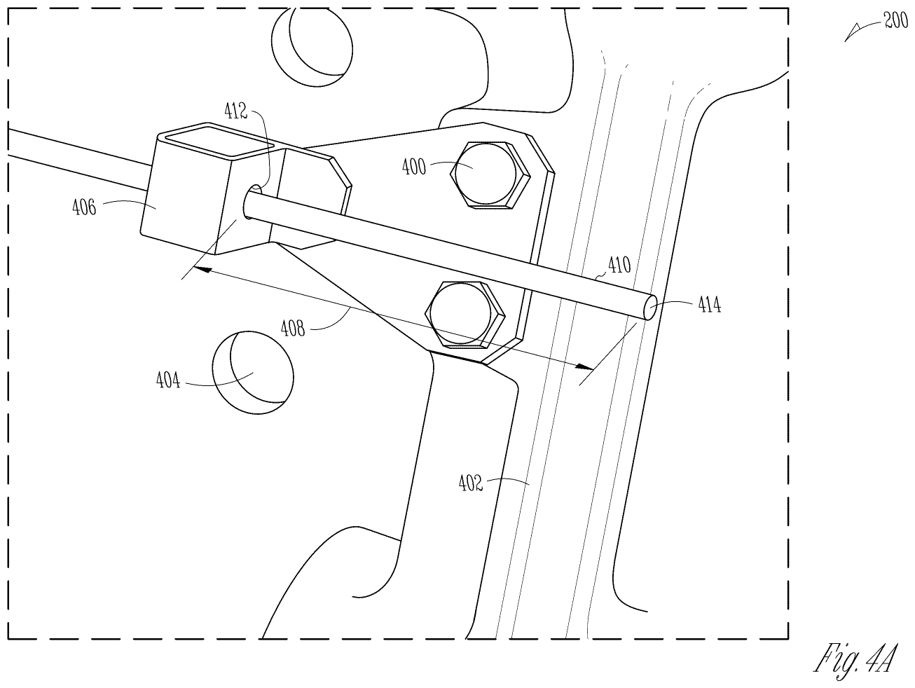

The reference template point indicia 302-308 can correspond to structures 400-406 (FIG. 4A) of the landing gear bogie 200. The reference template point indicia 302-308 can be broken lines that approximate the locations of the landing gear bogie structures 400-406 when the reference template 300 is viewed through a display of one of the devices 104 and 106 such that the reference template 300 aligns with the landing gear bogie structures 400-406 via the image capture component 110.

The landing gear bogie structures 400-406, which can be structures of the landing gear bogie 200 and a braking system of the aircraft 202, can correspond to various reference points on the landing gear bogie 200. These structures can be static such that the landing gear bogie structures 400-406 do not move during takeoff, flight, landing, or any other types of motion of the aircraft 202. The landing gear bogie structures 400-406 can include a bolt head, a screw head, or a boss. The landing gear bogie structures 400-406 can also correspond to a torque plate, a torque plate casting width, a torque plate casting depth, a wear pin housing through which a wear pin passes, a flange, a piston, or a portion of a piston. The landing gear bogie structures 400-406 can correspond to any type of structure associated with the landing gear bogie 200. Moreover, the since the landing gear bogie structures 400-406 can correspond to landing gear bogie reference points, as can be seen with the reference to FIG. 4A, the landing gear bogie reference points can correspond to at least two of the landing gear bogie structures 400-406.

While the reference template is described as having four reference template point indicia that can be matched to the landing gear bogie structures 400-406, in order to align the reference template 300 with the landing gear bogie 200, not all of the reference template point indicia need to be aligned with all of the of the landing gear bogie structures 400-406. Moreover, more than four reference points or less than four reference points can also be used. To further illustrate, some of the landing gear bogie structures may have corroded or have debris, which can impact the ability to align the reference template 300 with the landing gear bogie 200. Here, only two or three of the reference template point indicia 302-308 may need to be aligned with only two or three of the landing gear bogie structures 400-406.

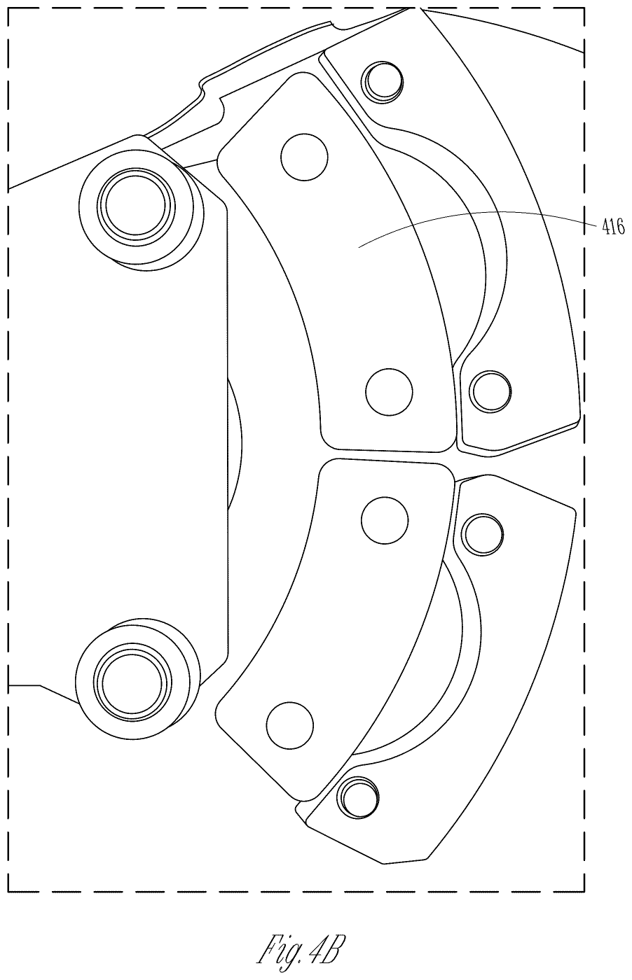

The client 112 can be pre-configured to include information relating to an aircraft type and landing gear bogie data associated with the aircraft. This information can be in the form of a data table 500 that includes a listing of different aircraft types 502-506 and associated landing gear bogie data 508-524 as shown with reference to FIG. 5. The landing gear bogie data 508-524 can include data for each landing gear bogie, such as the landing gear bogie 200, of a given aircraft, such as the aircraft 200.

The landing gear bogie data 508-524 can include information for a specific landing gear bogie. Thus, the port landing gear bogie data 508-512 can relate to landing gear bogie data for a port side of the aircraft types 502-506. Similarly, the starboard landing gear bogie data 514-518 can relate to landing gear bogie data for a starboard side of the aircraft types 502-506 while the nose landing gear bogie data 520-524 can relate to landing gear bogie data for landing gear bogies at the nose of the aircraft types 502-506.

The landing gear bogie data 508-524 can include reference templates having the reference template point indicia as discussed herein for the particular landing gear bogie for which the landing gear bogie data 508-524 is associated. In addition, the landing gear bogie data 508-524 can include instructions for how a user should orient an image capture device, such as the devices 104 and 106, when capturing an image of the landing gear bogie along with proper lighting for capturing the image.

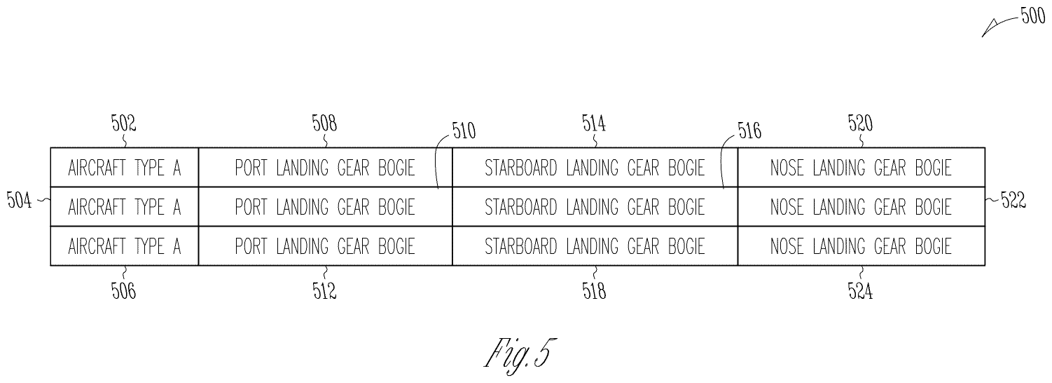

The landing gear bogie data 508-524 can also include data relating an original, or first, wear pin length 408 of a wear pin 410. The wear pin length 408 can be defined as a length between an end 412 of the landing gear bogie structure 406, which can be a wear pin housing, and an end 414 of the wear pin 410. The wear pin 410 can be for a brake pad 416 (FIG. 4B) of the landing gear bogie 200. The landing gear bogies 200 can include brakes that can function to arrest motion of the aircraft 202. The brakes can include brake pads that can contact a braking surface of the brakes, such as a rotor that rotates within a wheel assembly of the landing gear bogie. The brake pads can have a thickness that can decrease with use thereby decreasing the lifetime of the remaining brake pad. The thickness can decrease as the brakes wear as mentioned above. The wear pin length 408 can correlate to a thickness of a brake pads such that as the brake pad thickness decreases, the wear pin length 408 decreases to a second wear pin length 600 (FIG. 6) that can have a value that is less than a value of the wear pin length 408. Similar to the wear pin length 408, the wear pin length 600 can be defined as a length between the end 412 and the end 414.

In some instances, the landing gear bogie data 508-524 can correlate an expected lifetime of a brake pad based on differences between different values of wear pin lengths over time. In addition to the different wear pin lengths over time, the expected lifetime can take into consideration various factors, which can include environmental conditions in which the aircraft is operated as described above. In further examples, the server device 102 can function to make expected lifetime calculations in real time based on the different wear pin lengths sent from the devices 104 and 106 in real-time or near real-time.

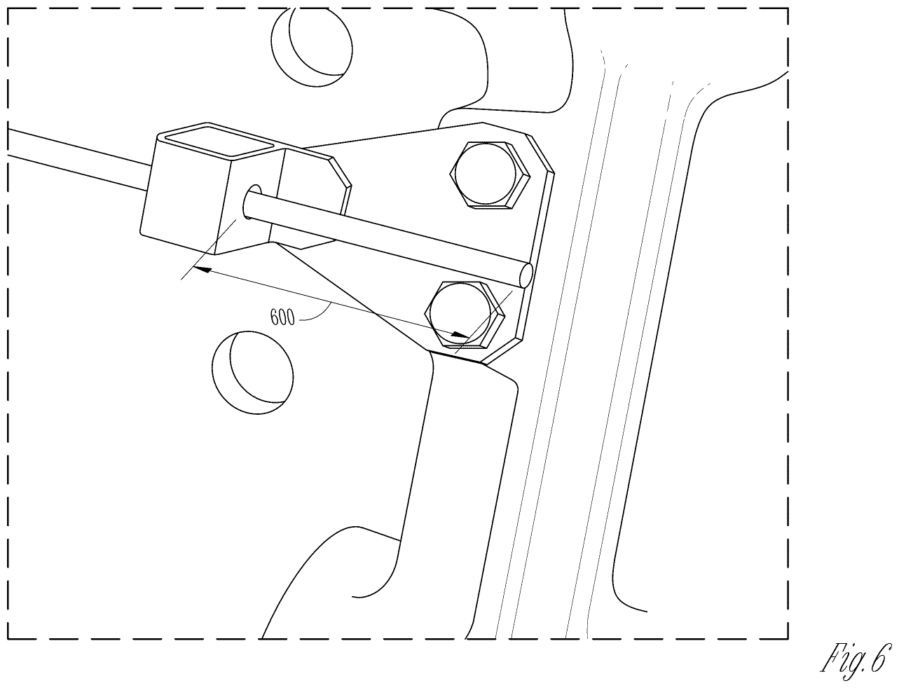

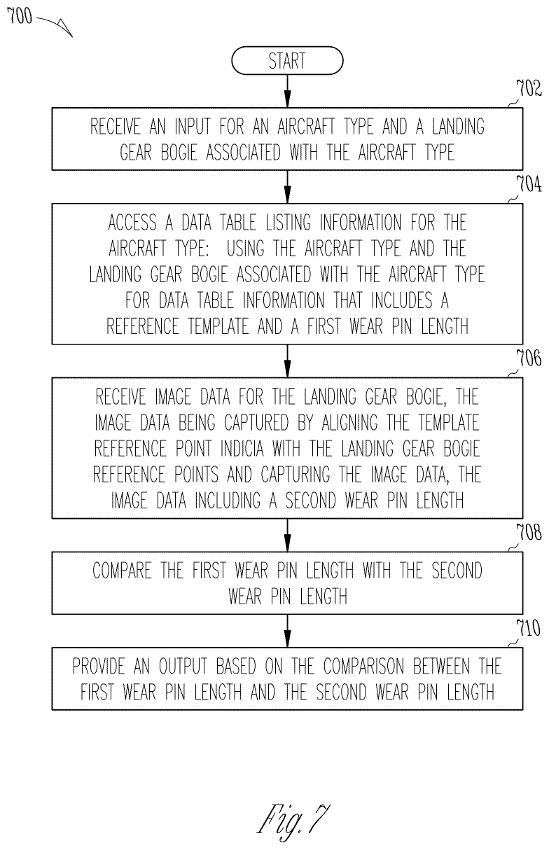

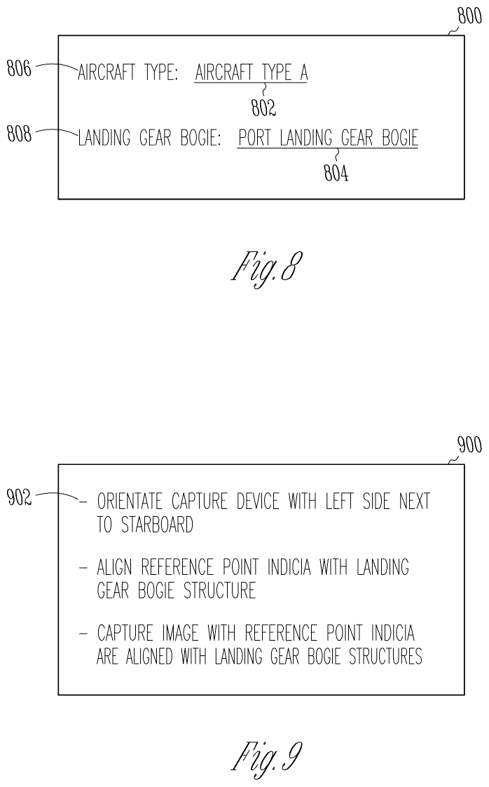

Now making reference to FIG. 7, a method 700 for using a reference template to determine a wear pin length is provided. The method 700 can be performed by the client 112 at one of the devices 104 and 106 during an inspection of an aircraft, such as the aircraft 202. Alternatively, the method 700 can be performed by the server device 102 where the server device can push data to the device 104 or 106. Initially, during an operation 702, an input that includes a type of aircraft and a specific landing gear bogie of an aircraft being inspected can be received by an entity performing an inspection of the aircraft. The input can be received via a user interface 800 that can be generated by the client 112. The user interface 800 can include a landing 802 that can receive an aircraft type as shown with reference to FIG. 8. The user interface 800 can also include a landing 804 that can receive a landing gear bogie identification.

As an example of the method 700 and referred to herein as “the example,” during the operation 702, the client 112 can generate the user interface 800 and cause presentation of the user interface 800 on the device 104. The user 114 can provide an input 806 that corresponds to “Aircraft Type A” at the user interface landing 802 during the operation 702. In addition, the user 114 provides an input 808 that corresponds to “Port Landing Gear Bogie” at the user interface landing 804 during the operation 702.

Returning attention to the method 700, after inputs are received during the operation 702, the method 700 performs an operation 704, where a data table that lists information for the aircraft type and the landing gear bogie associated with the aircraft type can be accessed and provided to the user. The data table can be accessed using the aircraft type provided during the operation 702. The data table can have the information as discussed herein, such as with reference to FIG. 5. More specifically, the information can include a reference template as discussed herein and a first wear pin length for the landing gear bogie also as discussed herein. The information can also include instructions relating to how a user should orient an image capture device relative to the aircraft and the landing gear bogie along with how the image capture device should be aligned with the landing gear bogie.

In the example, during the operation 704, information related to the Aircraft Type A, which is the aircraft type 502, and the Port Landing Gear Bogie, which is the landing gear bogie data 508, is accessed from the data table 500. This information can include the reference template 300 along with a first length of the wear pin 410, which in the example is 2.0 inches. In addition, the client 112 can generate a user interface 900 and cause presentation of the user interface 900 on the device 104. The user interface 900 can list information 902 that instructs the user 114 how to orient the device 104 and the image capture component 110. The client 112 can determine the orientation information by accessing the data table 500.

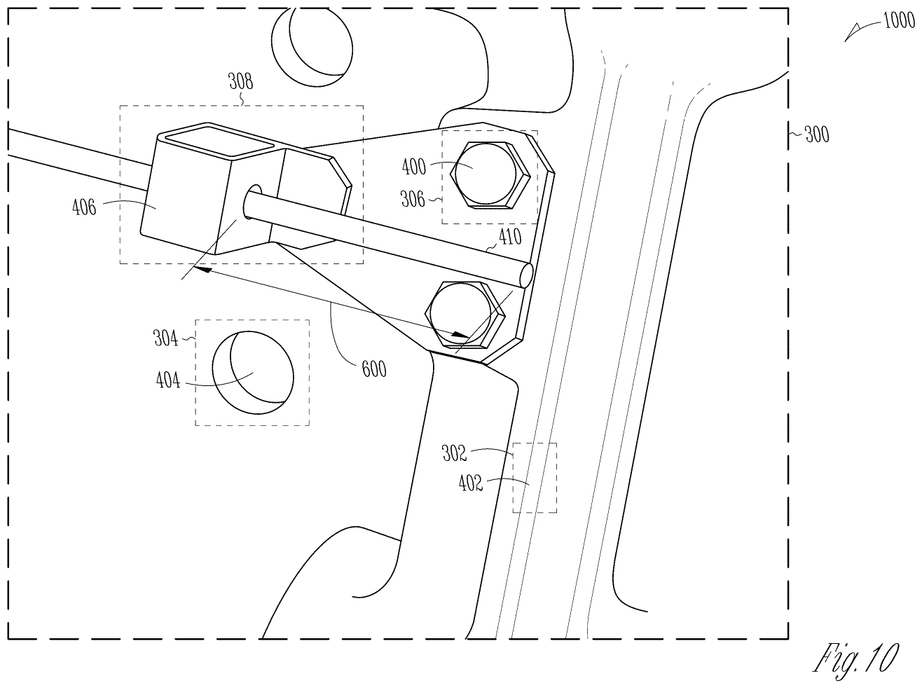

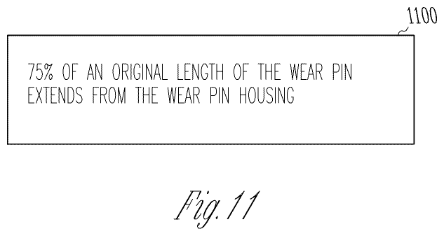

The user interface 900 indicates that the user 114 should orient the capture device, which can be the device 104, with the left side of the capture device next to starboard of the aircraft 202. The user interface 900 also instructs the user 114 to align the reference template point indicia 302-308 with the landing gear bogie structures 400-406. Once the reference template point indicia 302-308 are aligned with the landing gear bogie structures 400-406, the user interface 900 instructs the user 114 to capture an image. As shown in FIG. 10, the user 114 captures this image as image data 1000.

Returning attention to the method 700, image data associated with the landing gear bogie can be received during an operation 706. As discussed above, the image data is captured when the reference template point indicia align with the landing gear bogie structures. Here, the image data can include a second wear pin length that is different from the first wear pin length. The image data can be stored locally, such as at the device 104 via the client 112, or remotely, such as at the server device 102. As further image data is collected of the wear pin and the wear pin length, such as after every landing of the aircraft, image data can be calculated as discussed herein, and locally or remotely saved. The saved image data can be processed to determine a decay curve, as discussed further on.

During an operation 708, the first wear pin length can be compared with the second wear pin length. The comparison can include determining a difference between the first wear pin length, which can be a first value, and a second wear pin length, which can be a second value. In some instances, the difference can be provided to a remote server. Thus, if the client 112 locally determines a difference, the device 104 can send the difference to the server device 102. Otherwise, the captured second wear pin length can be sent to a remote server, such as the server device 102, which can determine the difference. Based on the comparison, the method 700 can provide an output between the first wear pin length and the second wear pin length during an operation 710.

In the example, during the operation 706, the client 112 can receive the image data 1000 upon capture. Here, the image data 1000 shows that the wear pin 410 has the wear pin length 600, which, in the example is 1.5 inches. During the operation 708, the client 112 can compare the wear pin length 600 with the wear pin length 408 and determine a difference of 0.5 inches between the wear pin length 600 and the wear pin length 408. The client 112 can then generate a user interface 1100, which can indicate that 75% of an original length of the wear pin 410 extends from the landing gear bogie structure 406.

While the discussion above relates to capturing one set of image data, i.e., aligning the reference template 300 with the landing gear bogie 200 a single time, examples envision performing the operations 702-706 multiple times prior to comparing the first wear pin length to the second wear pin length in the operation 708 and providing the output during the operation 710. Thus, any number of images can be captured in order to enhance the accuracy of determining a difference between a first wear pin length and a second wear pin length.

In some examples, a lifetime expectancy of a brake pad can be determined based on how a wear pin length decreases over time. Here, multiple wear pin lengths can be determined over time as described herein. To further illustrate, a wear pin length for a landing gear bogie can be determined every time an aircraft lands over a period of time, such as one year. Furthermore, a flight history of the aircraft that uses the landing gear bogie can be provided as location data input, such as at the client 112 or at the server device 102.

The flight history can include environmental conditions during landing of the aircraft that can include ambient temperature, humidity, and an elevation at which landings occurred that can correspond to location data. In examples where the device 104 is a smartphone, the device 104 can automatically determine this location input data through various applications that are loaded onto the device 104 and provide this information to the client 112 and/or the server device 102. Examples of applications that can provide environmental conditions can include a weather radar available from the National Oceanic and Atmospheric Administration, the weather application available from the Weather Channel™, the Travel Altimeter & Elevation application available from BranchenKing Ltd., and the like. In examples where the device 104 lacks any type of connectivity, such as a tablet, a user of the device can manually provide the location data input, which can then be provided to the client 112 that is on the device 104.

The flight history can also include flight characteristics, such as one of, or a combination of, a speed associated with a landing of the aircraft, a deceleration rate of the landing, locations of the landings of the aircraft, and a time of deceleration. The flight history can be downloaded from the aircraft to the device 104. Alternatively, the flight history can be downloaded from the aircraft to the server device 102. Moreover, automatic dependent surveillance-broadcast technologies can be aggregated using internet based services, such as FlightAware™, FlightRadar24, or the like.

Based on the flight history and/or the flight characteristics and the rate at which the wear pin length decreases overtime, a decay curve can be determined, which can be used to determine lifetime expectancy of the brake pad. The lifetime expectancy can be used to estimate when the brake pad should be replaced. For example, if an aircraft flies the same routes during a one-year period and the wear pin length decreases by 10% each year, the server device 102 or the client 112 can determine the life expectancy of a brake pad associated with the wear pin if the aircraft continues to fly the same routes. Any type of algorithm can be used to determine the life expectancy.

Spectral imagery can also be used in combination with capturing images of the wear pin length to further increase an accuracy of determining a difference in wear pin lengths. Here, spectral imagery can be used for temperature fluctuations that can occur which can increase the wear pin length, such as if the landing gear bogie is extremely hot, or can decrease the wear pin length, such as if the aircraft is landing in an extremely cold environment. Image data captured via spectral imagery can also be provided to the client 112 and/or the server device 102 to determine a difference between wear pin lengths as described herein. The device 104 can include an infrared camera to implement spectral imagery, or a separate device can be used to implement spectral imagery, where the additional device could be used according to the disclosure herein.

Any of the machines, databases, or devices shown herein may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 12 and 13. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

FIG. 12 is a block diagram 1200 illustrating a software architecture 1202, which may be installed on any one or more of the devices described above. FIG. 13 is merely a non-limiting example of a software architecture, and it will be appreciated that many other architectures may be implemented to facilitate the functionality described herein. The software architecture 1202 may be implemented by hardware such as a computer system 1300 of FIG. 13 that includes a processor 1302, memory 1304 and 1306, and I/O components 1310-1314. In this example, the software architecture 1202 may be conceptualized as a stack of layers where each layer may provide a particular functionality. For example, the software architecture 1202 includes layers such as an operating system 1204, libraries 1206, frameworks 1208, and applications 1210. Operationally, the applications 1210 invoke application programming interface (API) calls 1212 through the software stack and receive messages 1214 in response to the API calls 1212, according to some implementations.

In various implementations, the operating system 1204 manages hardware resources and provides common services. The operating system 1204 includes, for example, a kernel 1220, services 1222, and drivers 1224. The kernel 1220 acts as an abstraction layer between the hardware and the other software layers in some implementations. For example, the kernel 1220 provides memory management, processor management (e.g., scheduling), component management, networking, and security settings, among other functionality. The services 1222 may provide other common services for the other software layers. The drivers 1224 may be responsible for controlling or interfacing with the underlying hardware. For instance, the drivers 1224 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1206 provide a low-level common infrastructure that may be utilized by the applications 1210. The libraries 1206 may include system libraries 1230 (e.g., C standard library) that may provide functions such as memory allocation functions, string manipulation functions, mathematic functions, and the like. In addition, the libraries 1206 may include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1206 may also include a wide variety of other libraries 1234 to provide many other APIs to the applications 1210.

The frameworks 1208 provide a high-level common infrastructure that may be utilized by the applications 1210, according to some implementations. For example, the frameworks 1208 provide various graphic user interface (GUI) functions, high-level resource management, high-level location services, and so forth. The frameworks 1208 may provide a broad spectrum of other APIs that may be utilized by the applications 1210, some of which may be specific to a particular operating system or platform.

In an example, the applications 1210 include a home application 1250, a contacts application 1252, a browser application 1254, a book reader application 1256, a location application 1258, a media application 1260, a messaging application 1262, a game application 1264, and a broad assortment of other applications such as a third-party application 1266. According to some examples, the applications 1210 are programs that execute functions defined in the programs. Various programming languages may be employed to create one or more of the applications 1210, structured in a variety of manners, such as object-orientated programming languages (e.g., Objective-C, Java, or C++) or procedural programming languages (e.g., C or assembly language). In a specific example, the third-party application 1266 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1266 may invoke the API calls 1212 provided by the mobile operating system (e.g., the operating system 1204) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 108 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 13 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device (cursor control device) 1314 (e.g., a mouse), a disk drive unit 1316, a signal generation device 1318 (e.g., a speaker) and a network interface device 1320.

The drive unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media. Instructions 1324 may also reside within the static memory 1306.

While the machine-readable medium 1322 is shown in an example to be a single medium, the term “machine-readable medium” may include a single medium or multiple media (e.g., a centralized or distributed database, and/or associated caches and servers) that store the one or more instructions or data instructions 1324. The term “machine-readable medium” shall also be taken to include any tangible medium that is capable of storing, encoding or carrying instructions 1324 for execution by the machine and that cause the machine to perform any one or more of the methodologies of the present invention, or that is capable of storing, encoding or carrying data structures utilized by or associated with such instructions 1324. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1324 may further be transmitted or received over the network 108 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1324 for execution by the machine, and includes digital or analog communications signals or other intangible media to facilitate communication of such software.

In various example examples, one or more portions of the network 108 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 108 or a portion of the network 108 may include a wireless or cellular network, and the coupling 1382 may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

### ADDITIONAL EXAMPLES

Example 1 is a system, comprising: a processor; and memory comprising instructions that, when executed by the processor, cause the system to perform operations comprising: receiving an input for an aircraft type and a landing gear bogie associated with the aircraft type; accessing a data table listing information for the aircraft type using the aircraft type and the landing gear bogie associated with the aircraft type, the data table information comprising: a reference template having reference template point indicia corresponding to reference points of the landing gear bogie, the landing gear bogie reference points corresponding to structures at the landing gear bogie; and a first wear pin length for a wear pin of a brake pad of the landing gear bogie; receiving image data for the landing gear bogie, the image data being captured by aligning the reference template point indicia with the landing gear bogie reference points and capturing the image data, the image data including a second wear pin length; comparing the first wear pin length with the second wear pin length; and providing an output based on the comparison between the first wear pin length and the second wear pin length.

In Example 2, the subject matter of Example 1 includes, wherein the first wear pin length has a first value and the second wear pin length has a second value and the instructions for comparing the first wear pin length with the second wear pin length further cause the system to perform operations comprising: determining a difference between the first value with the second value; and providing the difference to a remote server.

In Example 3, the subject matter of Example 2 includes, wherein the instructions further cause the system to perform operations comprising: receiving a flight history of an aircraft having the landing gear bogie, the flight history including environmental conditions during landing of the aircraft that include ambient temperature, humidity, and elevation; determining a difference between the first value with the second value; determining a lifetime expectancy of the brake pad based on the difference between the first value and the second value and the flight history.

In Example 4, the subject matter of Examples 1-3 includes, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston.

In Example 5, the subject matter of Example 4 includes, wherein the reference template point indicia are broken lines that approximate locations of the landing gear bogie structures when the reference template is aligned with the landing gear bogie, the image data being captured by aligning the broken lines onto the landing gear bogie structures.

In Example 6, the subject matter of Examples 1-5 includes, wherein the instructions further cause the system to perform operations comprising receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

In Example 7, the subject matter of Example 6 includes, wherein the instructions further cause the system to perform operations comprising receiving location data input associated with an aircraft having the landing gear bogie, the location data including one of an ambient temperature, a location of the aircraft, and an elevation of the aircraft.

In Example 8, the subject matter of Examples 6-7 includes, wherein the instructions further cause the system to perform operations comprising receiving location data input associated with an aircraft having the landing gear bogie, the location data including one of an ambient temperature, a location of the aircraft, and an elevation of the aircraft.

In Example 9, the subject matter of Examples 1-8 includes, wherein the instructions further cause the system to perform operations comprising: determining orientation information of the system during capture of the image data based on the aircraft and the landing gear bogie; and displaying the orientation information to a user.

Example 10 is a system, comprising: a processor; and memory comprising instructions that, when executed by the processor, cause the system to perform operations comprising: receiving an input for an aircraft type and a landing gear bogie associated with the aircraft type; accessing a data table listing information for the aircraft type using the aircraft type and the landing gear bogie associated with the aircraft type, the data table information comprising: a reference template having reference template point indicia corresponding to reference points of the landing gear bogie, the landing gear bogie reference points corresponding to structures at the landing gear bogie; and a first wear pin length for a wear pin of a brake pad of the landing gear bogie; and displaying image data for the landing gear bogie, the image data being captured by aligning the reference template point indicia with landing gear bogie reference points and capturing the image data, the image data including a second wear pin length.

In Example 11, the subject matter of Example 10 includes, wherein the instructions further cause the system to perform operations comprising: comparing the first wear pin length with the second wear pin length; and providing an output based on the comparison between the first wear pin length and the second wear pin length.

In Example 12, the subject matter of Examples 10-11 includes, wherein the first wear pin length has a first value and the second wear pin length has a second value and the instructions for comparing the first wear pin length with the second wear pin length further cause the system to perform operations comprising: determining a difference between the first value with the second value; providing the difference to a remote server; receiving a flight history of an aircraft having the landing gear bogie, the flight history including environmental conditions during landing of the aircraft that include ambient temperature, humidity, and elevation; determining a difference between the first value with the second value; determining a lifetime expectancy of the brake pad based on the difference between the first value and the second value and the flight history.

In Example 13, the subject matter of Examples 10-12 includes, wherein the instructions further cause the system to perform operations comprising receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

In Example 14, the subject matter of Examples 10-13 includes, wherein the instructions further cause the device to perform operations comprising: determining orientation information of the system during capture of the image data based on the aircraft and the landing gear bogie; and displaying the orientation information to a user.

In Example 15, the subject matter of Examples 10-14 includes, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston and wherein the reference point indicia are broken lines that approximate locations of the landing gear bogie structures when the reference template is aligned with the landing gear bogie, the image data being captured by aligning the broken lines onto the landing gear bogie structures.

Example 16 is a non-transitory machine-readable medium having instructions embodied thereon, the instructions executable by a processor of a machine to perform operations comprising: receiving an input for an aircraft type and a landing gear bogie associated with the aircraft type; accessing a data table listing information for the aircraft type using the aircraft type and the landing gear bogie associated with the aircraft type, the data table information comprising: a reference template having reference template point indicia corresponding to reference points of the landing gear bogie, the landing gear bogie reference points corresponding to structures at the landing gear bogie; and a first wear pin length for a wear pin of a brake pad of the landing gear bogie; receiving image data for the landing gear bogie, the image data being captured by aligning the reference template point indicia with the landing gear bogie reference points and capturing the image data, the image data including a second wear pin length; comparing the first wear pin length with the second wear pin length; and providing an output based on the comparison between the first wear pin length and the second wear pin length.

In Example 17, the subject matter of Example 16 includes, wherein the first wear pin length has a first value and the second wear pin length has a second value and the operations of comparing the first wear pin length with the second wear pin length further comprise: determining a difference between the first value with the second value; providing the difference to a remote server; receiving a flight history of an aircraft having the landing gear bogie, the flight history including environmental conditions during landing of the aircraft that include ambient temperature, humidity, and elevation; determining a difference between the first value with the second value; determining a lifetime expectancy of the brake pad based on the difference between the first value and the second value and the flight history.

In Example 18, the subject matter of Examples 16-17 includes, wherein the operations further comprise receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

In Example 19, the subject matter of Examples 16-18 includes, wherein the operations further comprise: determining orientation information of an image capture device during capture of the image data based on an aircraft and the landing gear bogie; and displaying the orientation information to a user.

In Example 20, the subject matter of Examples 16-19 includes, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston and wherein the reference point indicia are broken lines that approximate locations of the landing gear bogie structures when the reference template is aligned with the landing gear bogie, the image data being captured by aligning the broken lines onto the landing gear bogie structures.

Example 21 is at least one machine-readable medium including instructions that, when executed by processing circuitry, cause the processing circuitry to perform operations to implement of any of Examples 1-20.

Example 22 is a method to implement of any of Examples 1-20.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A system, comprising:
a processor; and
memory comprising instructions that, when executed by the processor, cause the system to perform operations comprising:
receiving an input for an aircraft type and a landing gear bogie associated with the aircraft type;
accessing a data table listing information for the aircraft type using the aircraft type and the landing gear bogie associated with the aircraft type, the data table information comprising:
a reference template having reference template point indicia corresponding to reference points of the landing gear bogie, the landing gear bogie reference points corresponding to structures at the landing gear bogie; and
a first wear pin length for a wear pin of a brake pad of the landing gear bogie;
receiving image data for the landing gear bogie, the image data being captured by aligning the reference template point indicia with the landing gear bogie reference points and capturing the image data, the image data including a second wear pin length;
comparing the first wear pin length with the second wear pin length; and
providing an output based on the comparison between the first wear pin length and the second wear pin length.

2. The system of claim 1, wherein the first wear pin length has a first value and the second wear pin length has a second value and the instructions for comparing the first wear pin length with the second wear pin length further cause the system to perform operations comprising:
determining a difference between the first value with the second value; and
providing the difference to a remote server.

3. The system of claim 2, wherein the instructions further cause the system to perform operations comprising:
receiving a flight history of an aircraft having the landing gear bogie, the flight history including environmental conditions during landing of the aircraft that include ambient temperature, humidity, and elevation;
determining a difference between the first value with the second value;
determining a lifetime expectancy of the brake pad based on the difference between the first value and the second value and the flight history.

4. The system of claim 1, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston.

5. The system of claim 4, wherein the reference template point indicia are broken lines that approximate locations of the landing gear bogie structures when the reference template is aligned with the landing gear bogie, the image data being captured by aligning the broken lines onto the landing gear bogie structures.

6. The system of claim 1, wherein the instructions further cause the system to perform operations comprising receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

7. The system of claim 6, wherein the instructions further cause the system to perform operations comprising receiving location data input associated with an aircraft having the landing gear bogie, the location data including one of an ambient temperature, a location of the aircraft, and an elevation of the aircraft.

8. The system of claim 6, wherein the instructions further cause the system to perform operations comprising receiving location data input associated with an aircraft having the landing gear bogie, the location data including one of an ambient temperature, a location of the aircraft, and an elevation of the aircraft.

9. The system of claim 1, wherein the instructions further cause the system to perform operations comprising:
determining orientation information of the system during capture of the image data based on the aircraft and the landing gear bogie; and
displaying the orientation information to a user.

10. A system, comprising:
a processor; and
memory comprising instructions that, when executed by the processor, cause the system to perform operations comprising:
receiving an input for an aircraft type and a landing gear bogie associated with the aircraft type;
accessing a data table listing information for the aircraft type using the aircraft type and the landing gear bogie associated with the aircraft type, the data table information comprising:
a reference template having reference template point indicia corresponding to reference points of the landing gear bogie, the landing gear bogie reference points corresponding to structures at the landing gear bogie; and
a first wear pin length for a wear pin of a brake pad of the landing gear bogie; and
displaying image data for the landing gear bogie, the image data being captured by aligning the reference template point indicia with landing gear bogie reference points and capturing the image data, the image data including a second wear pin length.

11. The system of claim 10, wherein the instructions further cause the system to perform operations comprising:
comparing the first wear pin length with the second wear pin length; and
providing an output based on the comparison between the first wear pin length and the second wear pin length.

12. The system of claim 10, wherein the first wear pin length has a first value and the second wear pin length has a second value and the instructions for comparing the first wear pin length with the second wear pin length further cause the system to perform operations comprising:
determining a difference between the first value with the second value;
providing the difference to a remote server;
receiving a flight history of an aircraft having the landing gear bogie, the flight history including environmental conditions during landing of the aircraft that include ambient temperature, humidity, and elevation;
determining a difference between the first value with the second value;
determining a lifetime expectancy of the brake pad based on the difference between the first value and the second value and the flight history.

13. The system of claim 10, wherein the instructions further cause the system to perform operations comprising receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

14. The system of claim 10, wherein the instructions further cause the device to perform operations comprising:
determining orientation information of the system during capture of the image data based on the aircraft and the landing gear bogie; and
displaying the orientation information to a user.

15. The system of claim 10, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston and wherein the reference point indicia are broken lines that approximate locations of the landing gear bogie structures when the reference template is aligned with the landing gear bogie, the image data being captured by aligning the broken lines onto the landing gear bogie structures.

16. A non-transitory machine-readable medium having instructions embodied thereon, the instructions executable by a processor of a machine to perform operations comprising:
receiving an input for an aircraft type and a landing gear bogie associated with the aircraft type;
accessing a data table listing information for the aircraft type using the aircraft type and the landing gear bogie associated with the aircraft type, the data table information comprising:
a reference template having reference template point indicia corresponding to reference points of the landing gear bogie, the landing gear bogie reference points corresponding to structures at the landing gear bogie; and
a first wear pin length for a wear pin of a brake pad of the landing gear bogie;
receiving image data for the landing gear bogie, the image data being captured by aligning the reference template point indicia with the landing gear bogie reference points and capturing the image data, the image data including a second wear pin length;
comparing the first wear pin length with the second wear pin length; and
providing an output based on the comparison between the first wear pin length and the second wear pin length.

17. The non-transitory machine-readable medium of claim 16, wherein the first wear pin length has a first value and the second wear pin length has a second value and the operations of comparing the first wear pin length with the second wear pin length further comprise:
determining a difference between the first value with the second value;
providing the difference to a remote server;
receiving a flight history of an aircraft having the landing gear bogie, the flight history including environmental conditions during landing of the aircraft that include ambient temperature, humidity, and elevation;
determining a difference between the first value with the second value;
determining a lifetime expectancy of the brake pad based on the difference between the first value and the second value and the flight history.

18. The non-transitory machine-readable medium of claim 16, wherein the operations further comprise receiving flight characteristics associated with an aircraft, the flight characteristics including one of a speed associated with a landing of the aircraft, a deceleration rate of the landing, locations of landings, and a time of deceleration, wherein location data associated with the locations of the landings and the flight characteristics are sent to a remote location to determine a lifespan of the landing gear bogie brake pad.

19. The non-transitory machine-readable medium of claim 16, wherein the operations further comprise:
determining orientation information of an image capture device during capture of the image data based on an aircraft and the landing gear bogie; and
displaying the orientation information to a user.

20. The non-transitory machine-readable medium of claim 16, wherein the landing gear bogie reference points correspond to structures of the landing gear bogie comprising at least two of a bolt head, a torque plate casting width, a wear pin housing through which the wear pin passes, a torque plate casting depth, and a portion of landing gear bogie piston and wherein the reference point indicia are broken lines that approximate locations of the landing gear bogie structures when the reference template is aligned with the landing gear bogie, the image data being captured by aligning the broken lines onto the landing gear bogie structures.
